(19) United States
(12) Patent Application Publication
(10) Pub. No.: US 2015/0206078 A1
(43) Pub. Date: Jul. 23, 2015

(54) CLOUD-BASED ENERGY CONSUMPTION AND COLOR-CODED PERFORMANCE DATABASE SOLUTION FOR BUILDINGS

(71) Applicants: Sudhir K. Giroti, Wellesley, MA (US); Bhaskar Chandra Panigrahi, Southborough, MA (US)

(72) Inventors: Sudhir K. Giroti, Wellesley, MA (US); Bhaskar Chandra Panigrahi, Southborough, MA (US)

(73) Assignee: 1EFFICIENCY, INC., Framingham,, MA (US)

(21) Appl. No.: 14/600,776

(22) Filed: Jan. 20, 2015

Related U.S. Application Data
(60) Provisional application No. 61/929,514, filed on Jan. 21, 2014.

(51) Int. Cl. G06Q 10/06; G06Q 50/16

(52) U.S. Cl. CPC G06Q 10/0631; G06Q 50/16

(57) ABSTRACT

A database for the aggregation of data to support the management and upholding of various properties includes a number of interrelated databases, third party information, and an interpretive system that enables quick understanding of the efficiency of a property to be ascertained. The software for such analysis is preferably cloud based and accessible from any location. The software makes a number of analytical calculations and assigns visual codes or cues to each property based on these performance variables. In some embodiments, the system may suggest certain actions to be taken in response to certain perceived situations.

### CLAIM OF PRIORITY

This application claims priority to U.S. Application 61/929,514 filed on Jan. 21, 2014, the contents of which is herein fully incorporated by reference in its entirety.

### FIELD OF THE EMBODIMENTS

The field of the invention and its embodiments relates to a user friendly database which provides visual indicators relating to efficiency and performance of real estate properties including virtually any type of building or facility. In particular, a system is employed that uses various algorithms on data collected from property systems, devices, and publicly available information to create an energy and efficiency profile for commercial and industrial properties.

### BACKGROUND OF THE EMBODIMENTS

Annually, tens millions of buildings in the world spend billions of dollars of energy, such as heating or cooling, of which significant amount is wasted. For example, in the United States, approximately five million commercial and industrial buildings spend about $200 billion on energy, of which nearly 30% ($60 billion) can be saved through improved energy efficiency. However, much of these savings are untapped because many building owners, tenants, and investors do not properly appreciate the potential savings during property management. According to United States Department of Energy, “information feedback can introduce savings of about 15% ($30 billion) or higher”—a significant business opportunity.

In addition, The International Energy Agency has stated that “customers respond to prices by switching supplier, shifting and reducing demand will help improve efficiency, flexibility, dynamism, and innovation throughout the electricity supply chain.” In turn, switching suppliers by consumers and property proprietors amounts to a $100 billion dollar market which has the potential to grow through customer education, system standardization, and easy user experience.

As such, there have been attempts to enter this market, however, these attempts have been met with tepid success. A few existing solutions provide energy consumption analysis systems that require installation of new hardware or software in or around the property to extract data from systems within a building and third parties and then provides a means to analyze the data about a building's energy usage. Yet another approach involves providing home premise based energy management system for homes to manage appliances such as a dishwasher, dryer, refrigerator, and the like. In some such systems, appliances can be turned on and off for effective energy management. In others, a home energy device, or gateway, can receive consumption data for a home's energy usage from the utility company and appliances within a home.

However, these and other existing solutions are focused on providing limited energy information with regard to a specific building and many require proprietary hardware or software to be used in the building. Efforts to “scale up” investments across multiple properties are difficult due to these system's inability to manage energy consistently across geographically diverse properties due to variation in buildings and lack of aggregated energy data and performance data. Typically, utility companies only provide monthly billing per building so managers rekey this data into spreadsheets and standalone applications to consolidate this data for their portfolio. This results in time consuming and painful process.

Additionally, energy data is often difficult to acquire, proprietary in nature, and many times is incomplete. The utility companies do not generally have the means or desire to offer this data thus this data remains untapped primarily due to inaccessibility. New “green button” standards seem to address this issue, however, adoption is still in its infancy and aggregating data across numerous buildings remains a challenge. The customer's ability to switch suppliers and shift peak demand requires access to energy usage and pricing data which is largely unavailable to consumers in the energy value chain.

Various devices are known in the art. However, their property and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

This present invention and its embodiments generally describes and teaches a cloud-based energy database and system that comprises of a plurality of databases such as energy consumption database, energy performance database and others, a plurality of connectors that access data from a number of sources to feed the energy database and a system or capability that provides authorized users or systems access to this database. The energy database system accesses data from numerous source systems such as 1) existing property devices including but not limited to electricity, gas and water meters, sub-meters, solar meters, thermostats, and building automation systems, 2) utility providers, 3) public domain sites, 4) weather stations and 5) third parties. This consumption, or usage, data is preferably accessed remotely and without the installation of any dedicated hardware or software in or around the property. The consumption database includes many sources of data including but not limited to electronic devices, appliances, and internet enabled meters that can be a source of the utility consumption, production, and/or regulation and control within the property. It may also include the various property specific devices under the umbrella of the “internet of things” or interconnected internet enables devices.

The data sourced and retrieved may allow for the formation of a variety of performance indexes by which each property can be coded and ranked/compared to other existing properties in a portfolio or outside a particular portfolio. Such indexes may include but are not limited to: a total energy consumed and cost index, total utilities consumed and cost index, total water, electricity, gas, oil, etc. that are consumed and cost index, total sewer cost index, any of the foregoing per occupant index, any of the foregoing per square foot or 100 square feet index, comparison of all by benchmark index, total carbon/CO₂ emission, and comparing any of the foregoing by tenant, by buildings in portfolio of a client, by industry benchmark, by proprietary benchmarks.

These aforementioned indexes help compare any number of properties against each other within a user created portfolio and against publically available benchmark data. For example, the cost of electricity used per square foot can be used as a mechanism to compare certain properties that may not necessarily be of the same square footage. The index then becomes a standard that can be used to compare properties that differentiate on any number of features. As an example, a 100,000 square foot property with 200 occupants may spend $100,000 per year on electricity consumption, whereas another property which is 50,000 square feet and has 75 occupants may be spending $75,000 per year on electricity consumption. Clearly, in this example, the larger property spends more on electricity consumption than the smaller property. However, based upon two system indexes (i.e. dollars spent/sq. ft. and dollars spent/occupant) the larger property spends $1.00/sq. ft. on electricity and $500.00/occupant whereas the smaller property spends $1.50/sq. ft. and $1,000.00/occupant. Thus, the larger property has better energy efficiency and performance as it consumes less electricity per square feet and costs less per occupant compared to the smaller property, even though the actual spending and total occupants are more than the smaller property.

Based upon the benchmark data and other retrieved data from utilities, third parties, devices, thermostats, etc. a holistic analysis is performed for the portfolio of properties and each property is color coded to reflect its performance for any of the above categories and others not named. For example, a building that is under performing compared to benchmark/data will be color coded as “red,” a building that is over performing compared the benchmark/data will be coded “green,” and a building that is performing at par with benchmark/data may be coded as “orange.” Other colors may also be utilized to provide an indication of a building's performance in multiple areas and provide further depth to the color coding and rankings of performances.

In one embodiment of the present invention there is a property performance database system for monitoring at least one utility and measuring performance of the property, the system having a processor based computing device capable of being connected to a network; a computer readable storage medium storing one or more programs for execution by the processor based computing device; wherein the one or more programs has a plurality of interrelated utility based databases for at least one property, the databases having normalized utility consumption data, consumption data, color coded performance data, or benchmark data, or any combination thereof; a weather database, wherein the data in the weather database is used to normalize consumption data for the at least one property; and wherein the plurality of interrelated utility based databases and the weather database receive information from third parties over the network.

In another aspect of the present invention there is a method of compiling and interpreting performance data, the method having the steps of: providing a computer readable storage medium storing one or more programs for execution by one or more processors, wherein the one or more programs has a plurality of interrelated utility based databases for at least one property, the databases having normalized utility consumption data, consumption data, color coded performance data, or benchmark data, or any combination thereof, a weather database, wherein the data in the weather database is used to normalize consumption data for the at least one property, wherein the plurality of interrelated utility based databases and the weather database receive information from third parties over the network; retrieving data from at least one third party to be analyzed by the one or more programs, assigning at least one color to a property based on an analysis of the third party data, wherein the color signifies a performance factor of the at least one property.

In general, the present invention succeeds in conferring the following, and others not mentioned, benefits and objectives.

It is an object of the present invention to provide a performance database that provides property performance data in real time.

It is an object of the present invention to provide a performance database that utilizes a variety of information to provide a comprehensive overview of energy expenditures and consumption of properties.

It is an object of the present invention to provide a performance database that provides a wide range of data and information based upon different granularity from a top down portfolio wide view of a number of buildings down to a meter or device level and bottom up view of each device such as a thermostat, meter, etc.

It is an object of the present invention to provide a performance database that provides access to both human users and computer systems of all kinds.

It is an object of the present invention to provide a performance database that provides a piecemeal capability of offering consumption and performance data to an aggregated data set, direct access to database, and indirect access through an application and programmatic access through an application programming interface.

It is an object of the present invention to provide a performance database that uses weather information to account for external variables and normalizing data in comparing properties.

It is an object of the present invention to provide a performance database that normalizes data so each property can be compared against any other property.

It is an object of the present invention to provide a performance database that can be accessed from almost any remote location through a dashboard, application programming interface, or the like.

It is another object of the present invention to provide a performance database that stores current and historical data for comparisons across varying time periods.

It is another object of the present invention to provide a performance database that retrieves data in accordance with a user customized schedule for each utility, property, and the like.

It is another object of the present invention to provide a performance database that implements a color based coding system to identify property and utility performance and consumption.

It is another object of the present invention to provide a performance database that is used to identify anomalies and saving opportunities within a building portfolio.

It is another object of the present invention to provide a performance database that is used to manage building more efficiently for instance using energy efficiency measures.

It is yet another object of the present invention to provide a performance database that contains a number of conceptual and/or physical tables to parse and hold the retrieved/gathered information.

### BRIEF DESCRIPTION OF THE DRAWINGS

FIG. 1 is a diagram of a high level system overview of an embodiment of the present invention.

FIG. 2 is a flowchart illustrating the sharing of data between components of the system.

FIG. 3 is a flowchart illustrating a process of obtaining data from a utility provider to be used in an embodiment of the present invention.

FIG. 4 is a flowchart illustrating a process of assigning color codes to a property based on performance as it relates to energy usage, expenditures, and other system variables.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

The “building of the internet of things” or the concept that encompasses the highest, most generalized layer of intelligence and user interface that ties together connected devices and web services is an emerging race which this invention and its embodiments addresses. In order to create this “internet of things” (i.e. interconnected, data sharing devices) a building or interconnectivity must be achieved that allows all “internet of things” devices to share data and otherwise communicate across standard protocols. This invention and its embodiments focus strongly on this concept and bringing it to the masses in a formidable and precise package by creating a system that aggregates dissimilar data from a variety of sources and interprets it in a central location. In turn, the present invention and its embodiments provides for the formation of a variety of performance indexes by which each real estate property can be coded and ranked/compared to other existing properties in a portfolio or outside a particular portfolio.

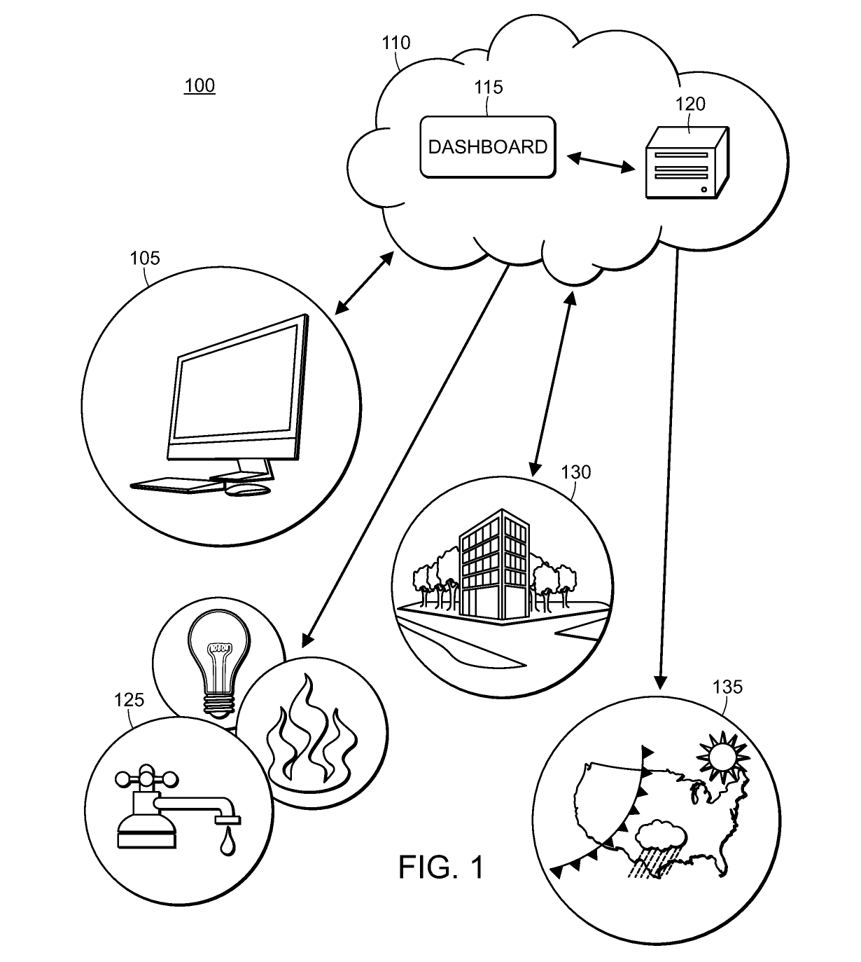

Referring now to FIG. 1, there is a high level overview of an embodiment of the system 100. The system 100 is available in the cloud 110 through a dashboard 115 or application programming interface (API) and server database 120. The user can interact with the dashboard 115 to monitor each of the properties 130 in the system 100 and the information is stored in the server database 120.

Since the system 100 exists in the cloud 110, the system 100 can be accessed remotely by a user 105 at virtually any location capable of being capable of accessing a network such as but not limited to a wide area network (WAN), local area network (LAN), wireless wide area network (WWAN), internet, intranet, private shared wireless network, and the like or any combination thereof. The network need not be physically centralized, but rather just provide a communication channel between the identified and other interrelated parts of the present invention. The user 105 can be any person, a system of another computer, or another machine.

A user 105 accesses the system 100 through the cloud 110 and can then upload particular information pertinent to a property 130. The property 130 may be any residential, commercial, and/or industrial property or any combination thereof. Each property 130 may have any number of utilities 125 attributable to that particular property 130. Examples of utilities 125 may include but are not limited to water utility providers, electric utility providers, oil utility providers, sewer utility providers, telecommunication providers, internet service providers, solar utility providers, and gas utility providers. Additionally the input of a particular location attributable to property 130 can provide for weather reports 135 to be accessed by the system 100. Further, any utility 130 information and weather reports/information 135 may be third party information accessed by the system for analytical purposes as well as property specific information.

All of the above and other not explicitly noted information is then compiled in the server database 120 where it is analyzed and compared amongst the various type of data. The user 105 then, via the dashboard 115, accesses this information on their electronic device which may be but is not limited to a laptop computer, desktop computer, PDA, tablet, cellular phone, multimedia players, gaming system, smart watch, and the like or any combination thereof.

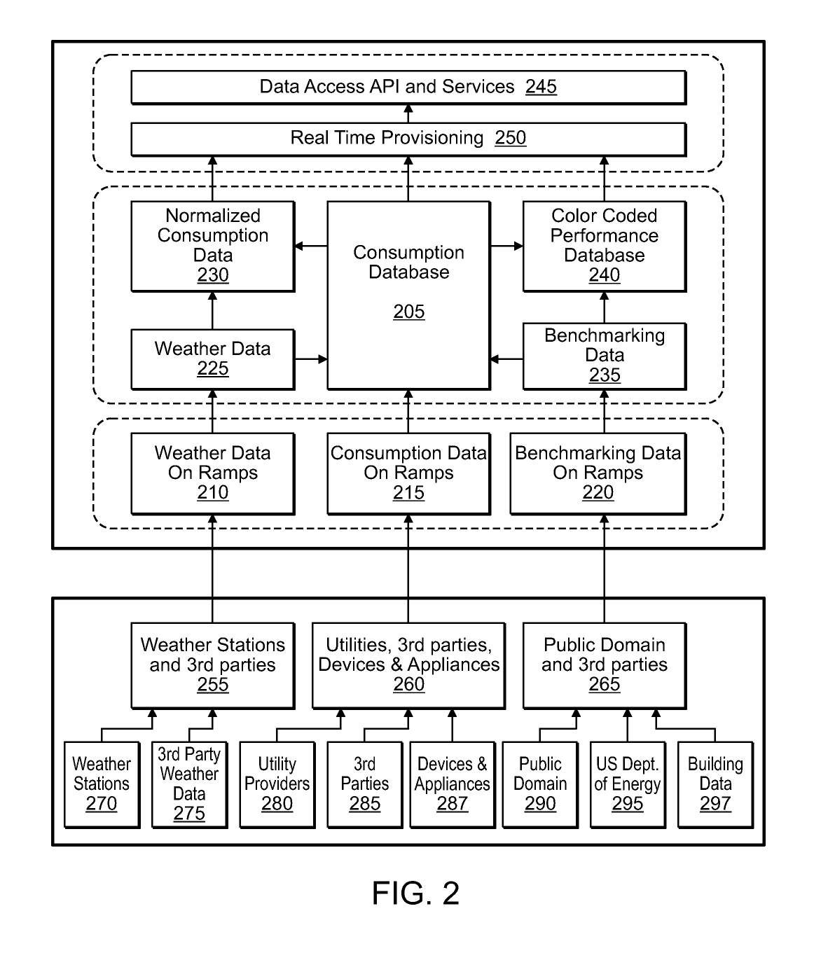

Referring now to FIG. 2, there is a graphical overview of the interrelationship between the back end databases and the third party information retrieved by the system. As shown, there are a number of databases which includes but is not limited to a consumption database 205, a weather database 225, a benchmark database 235, a color coded performance database 240, and a normalized consumption database 230.

The consumption database 205 is generally a cloud based database which includes utility usage (i.e. electricity, water, gas, oil, etc.) and consumption data for any given property present in the system. The consumption database 205 may contain tables and data related to information about an electricity, water, gas or oil provider such as National Grid, and this includes all the utilities provided by each utility provider (i.e. one provider supplying multiple utilities).

The database may further contain property related data such as its address, information about a property such as its square footage, total occupants at any given time, details about appliances and equipment in buildings, and the type of property but not limited to a school, hospital, office building, etc. Additional data may cover billing related data, meter related data tariff data, and the like.

The weather database 225 contains weather data for a particular geographic location and serves to normalize the consumption data for each property or groups of properties.

The benchmark database 235 contains reference data set(s) for utility usage and consumption for buildings based upon variable characteristics such as but not limited to geography, physical location, size (sq. ft.), floor/levels, usage, number of occupants, property type, and property age that serve as a reference point for comparing and benchmarking properties contained within the system.

The color coded performance database 240 assigns a color code to designate the energy efficiency and performance of each property in the system. For example, a “red” property may signify an underperforming property compared to the benchmark data in the benchmark database 235, whereas a “green” property signifies a building performing better than the benchmark data. Various other colors such as orange, yellow, purple, blue, green, etc. can be used to signify varying ranges of performance and other system variables.

The normalized consumption database 230 contains information (data) that is normalized for each property based upon a variety of factors including but not limited to weather, number of occupants, square footage, etc. thus enabling each property to be compared against any other property contained in the system or otherwise. Normalization results in properties of numerous sizes, types, ages, functions, occupants, and other variables to be compared seamlessly to one another. For instance, two office buildings each of a different square footage and number of occupants can be compared to each other if the data attributable to each property is normalized. As a result of the normalization process, numerous indexes such as dollars consumed for a utility per square foot of the property can be used as a way to compare their relative performance. Additionally, dollars consumed per occupant or utility consumption per occupant may also be used to compare properties.

Each of these databases are interconnected with one another and further associated with data “on ramps” which serve as avenues or connectors for the flow of data into the system. This enables the system to keep all information contained therein current by sourcing or retrieving the data from various third parties and combining that data with data from each particular property in the system.

As shown, there may be a weather data “on ramp” 210, a consumption data “on ramp” 215, and a benchmark data “on ramp” 220. The weather data “on ramp” 210 receives information from block 255 which derives information from weather stations 270 and various other third parties 275. This data then flows into the system where it is used to normalize the consumption data against various geographic and physical location variants as related to weather (i.e. average temperatures, rainfall, etc.).

The consumption data “on ramp” 215 pulls and provides information relating to utilities and third parties and numerous wirelessly enables devices and appliances 260. Utility providers 280, utility related third parties 285, and numerous devices and appliances 287 provide information, as it relates to utilities, when requested by the system. This may be any type of consumption data and may include expenditures based on the consumption levels.

Further, the devices and appliances 287 may be part of the larger “internet of things” or interconnectivity of smart device that may or may not require human-human or human-computer direct interaction to facilitate the sharing and transport of data. Virtually any device or appliance can contain a central processing unit, memory, and power sources or resources that enable it to provide information about itself or the environment in which it is contained. Thus, “internet of things” devices can be used to monitor and/or control mechanical and electrical (amongst others) systems in a property and systematically provide that information to another source as shown.

In order to properly provide data which the consumption data to be compared, there is a benchmark data “on ramp” 220. There are a number of third parties and publicly available information 265 for which the system can retrieve. The system may use data in the public domain 290, a government center such as the U.S. Department of Energy 295, and general property data 297 as it relates to a particular property in the system. The benchmark data can then be compared against the consumption data and color coding assigned on this basis.

As noted above, the data may be provisioned in real time 250 and may be used by any authorized application to build, deploy or run systems or applications. In some instances, the data is delivered as a data feed. Finally, the data is accessed by an end user, as shown in FIG. 1, through an API, web service interface, and the like or any combination thereof 245.

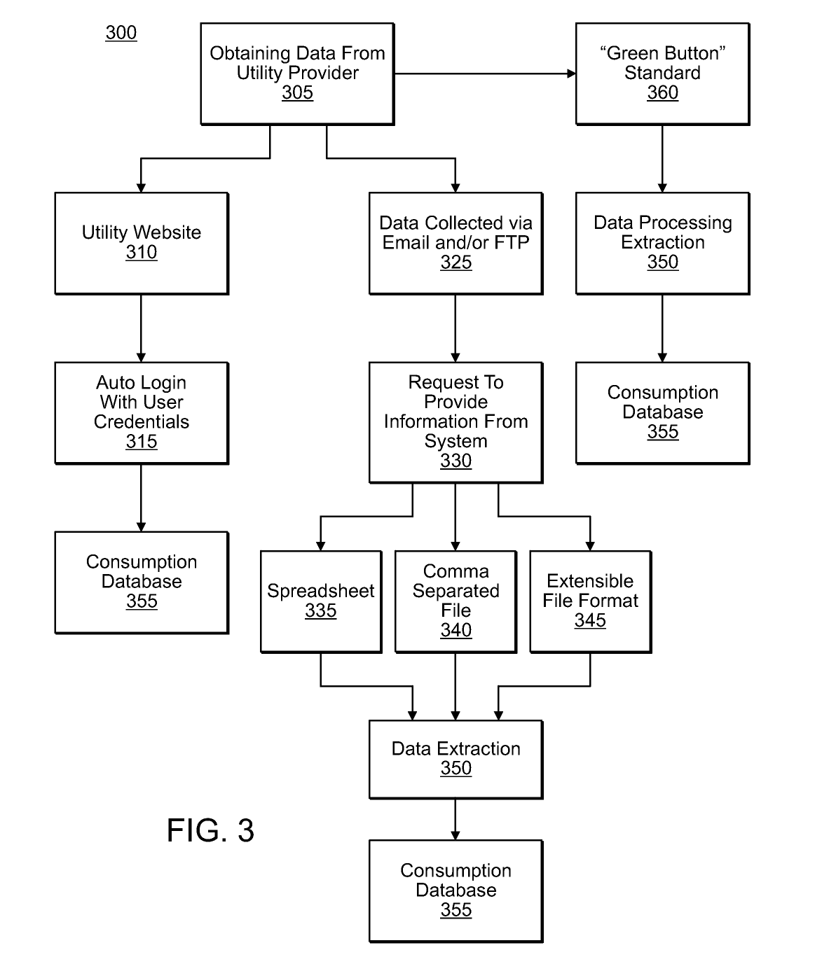

FIG. 3 is a flowchart that demonstrates a general process or method 300 of populating the consumption database with usable data. Other databases in the system may follow the same or a different methodology in retrieving and sourcing their data.

In step 305, the system or a user is actively attempting to obtain data from a utility provider in order to populate the consumption database of the system. This may be done in accordance with a preset or prearranged frequency setting or may be done actively in order to “refresh” the system.

In step 310, data to be added to the system is accessed from the utility provider's web site. The system has the ability mock and/or mimic a user's actions and access data directly from the utility provider's web site. However, for such action to be taken by the system, a user is required to provide the system with their utility provider issued username, password, or other account identifier.

In step 315, the system then stores this information to mock a user's log-in upon the requirement to retrieve or source data. This enables subsequent attempts to source new information from that particular utility provider to occur seamlessly and without user intervention.

In step 355, the data is sourced and added and/or updated to the consumption database as necessary.

In some instances, the user and/or system cannot retrieve the necessary information via the utility provider's web site and must seek another source of information obtainment. In step 325, the data may be collected by the system via electronic mail, FTP server, or other electronic communication means.

In step 330, the system sends a request or pings the utility provider's system to cause consumption and expenditure information to be forwarded to a particular electronic mail address or other electronic communication account.

In steps 335, 340, and 345 the information can be forwarded from the utility provider to the system in an excel spreadsheet, a comma separated file, an extensible file format (XML) file or any other file format proprietary or non-proprietary, or any combination thereof.

In step 350, the system extracts the data from any of the above data formats and parses it to access the utility consumption and other data from the files supplied by the utility provider.

In step 355, the consumption data is sourced and added and/or updated to the consumption database as necessary.

Yet in step 360, another method of data retrieval is outlined. Here, various emerging initiatives such as the “green button standard” require the disclosure of consumption and/or expenditure information as it relates to a property's utilities. Thus, through such actions the system will put in a request under the proper initiative to receive the required data. In some instances, the utility provider will automatically send data under such an initiative to the system.

In step 350, the system extracts the data from any of the above data formats and parses it to access the utility consumption and other data from the files supplied by the utility provider.

In step 355, the consumption data is sourced and added and/or updated to the consumption database as necessary.

In the above process, similar processes may be used to source or retrieve data required by any of the other databases and may operate generally as shown in FIG. 2. The exact process may be the same or different than the method 300 described above but should sufficiently source/retrieve, parse, and make updates to existing data as necessary.

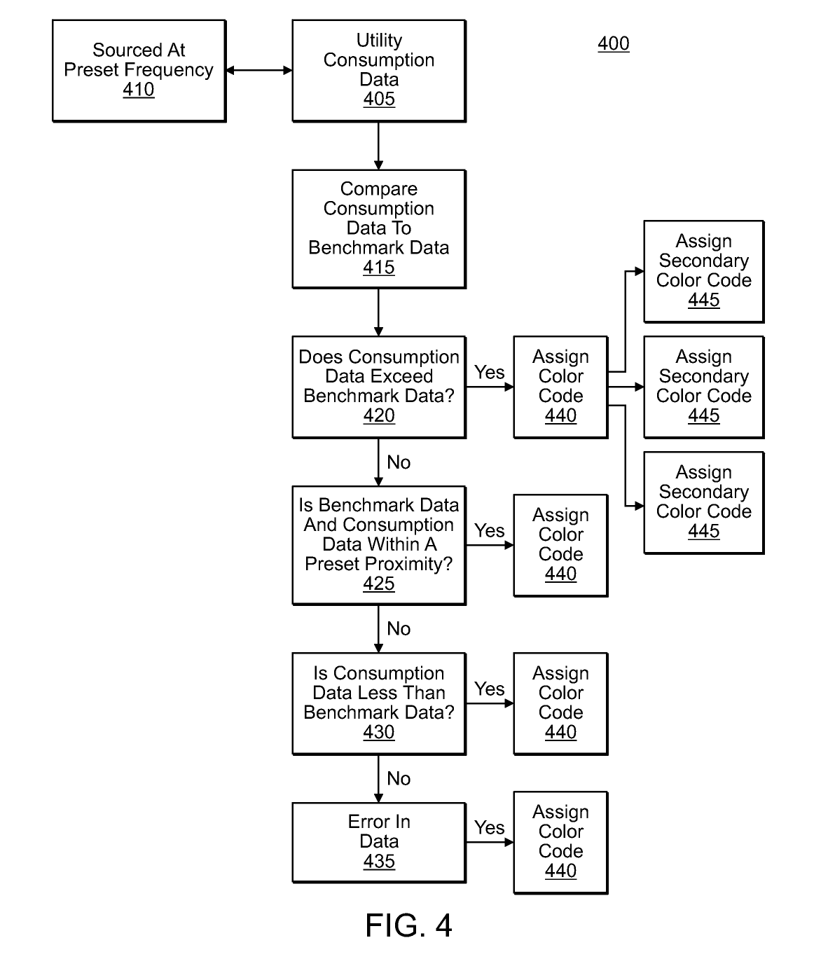

Referring now to FIG. 4, there is a method 400 for sourcing data and applying a color code to the data to provide a visual indication to the user as to a particular property or groups of properties performance and efficiency as it related to normalized energy standards.

In step 405, the utility consumption data sourced as previously described exists in the consumption database of an embodiment of the present invention. As shown in step 410, this data may be sourced at a preset frequency in accordance with system or user specifications.

In step 415, there is a comparison made between the utility consumption data and the benchmark data. The comparison between these two databases is what drives the color coding process. However, the normalization of the data also plays a pivotal role in permitting the analysis between various buildings based off these normalized standards. Thus, geographically and physically distinct buildings can be compared by their utility consumption and expenditure data to the benchmark data to arrive at an indicator of performance and efficiency for the particular property.

In step 420, the system checks to see if the values of the particular category or type of consumption data exceeds the benchmark data. If these consumption data values are indeed higher, then the system ascertains how much higher (i.e. percentage, points, values, etc.) and assigns a color code in step 440.

In step 425, if the system has determined that the consumption data does not exceed the benchmark data, then the system checks to see if the consumption data is less than the benchmark data but within a predetermined proximity (i.e. <5%). If this is the case, a color code is assigned to the data value in step 440. This color code is preferably different and distinct in color from the previously assigned color code.

In step 430, the system checks to see if the consumption data is less than the benchmark data by a margin predetermined in the system. This margin may vary but should be on the lower boundary for what was determined to be within a “proximity” to the benchmark data in step 425. If the data is found to be in the category, then a color code is assigned to the data in step 440.

In step 435, the system registers an error in the data collection/analysis or determines no values exist for the particular categorical value. In step 440, the appropriate color code is applied to these data values.

Further, as shown in step 440, the assigning of a color code may results in the assigning of secondary color codes in step 445. A secondary color code may be a color code assigned in addition to the color code assigned in step 440. This may involve a building/property receiving more than one color code or a utility receiving more than one color code. For example, a property having utility designation of electricity may receive one color code for consumption of electricity and another color code for the electricity expenditure. Such dual coding allows one to find discrepancies in utility provider models and find those who offer a better deal for a particular property or property type.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A property performance database system for monitoring at least one utility and measuring performance of the property, the system comprising:
a processor based computing device capable of being connected to a network;
a computer readable storage medium storing one or more programs for execution by the processor based computing device;
wherein the one or more programs has a plurality of interrelated utility based databases for at least one property, the databases having normalized utility consumption data, consumption data, color coded performance data, or benchmark data, or any combination thereof;
a weather database,
wherein the data in the weather database is used to normalize consumption data for the at least one property; and
wherein the plurality of interrelated utility based databases and the weather database receive information from third parties over the network.

2. The property performance database system of claim 1 wherein consumption data for the at least one property is compared against benchmark data.

3. The property performance database system of claim 2 wherein the at least one property is prescribed at least one color coded designation based up the comparison between the consumption data and the benchmark data.

4. The property performance database system of claim 1 wherein at least one color coded designation is given to each of the at least one utilities.

5. The property performance database system of claim 4 wherein each of the at least one utilities receives more than one color coding.

6. A method of compiling and interpreting performance data, the method comprising:
providing a computer readable storage medium storing one or more programs for execution by one or more processors,
wherein the one or more programs has a plurality of interrelated utility based databases for at least one property, the databases having normalized utility consumption data, consumption data, color coded performance data, or benchmark data, or any combination thereof,
a weather database,
wherein the data in the weather database is used to normalize consumption data for the at least one property,
wherein the plurality of interrelated utility based databases and the weather database receive information from third parties over the network;
retrieving data from at least one third party to be analyzed by the one or more programs,
assigning at least one color to a property based on an analysis of the third party data,
wherein the color signifies a performance factor of the at least one property.

7. The method of claim 6 further comprising the step of:
accessing the one or more programs via a processor based computing device capable of being connected to a network,
wherein content access is determined by the user credentials supplied by a user.

8. The method of claim 6 further comprising the step of:
querying at least one of a plurality of categories of the at least one database.

9. The method of claim 6 further comprising the step of:
a user taking at least one action in response to the at least one color assigned to the at least on property.

10. The method of claim 6 wherein the at least one third party is a weather station, utility provider, or other publicly available information, or any combination thereof.

11. The method of claim 7 further comprising the step of:
the user querying at least one of a plurality of categories of the at least one database.
